(19) United States
(12) Patent Application Publication
(10) Pub. No.: US 2023/0168786 A1
(43) Pub. Date: Jun. 1, 2023

(54) Methods and Systems for Location-Based Accessing of Predesignated Data Payloads Using Extended Reality

(71) Applicant: Verizon Patent and Licensing Inc., Basking Ridge, NJ (US)

(72) Inventors: Viraj C. Mantri, Mumbai (IN); Ajai Prabhu Gujuluva Santharam, Madurai (IN); Srividhya Parthasarathy, Chennai (IN); Pranusha Naandi, Gachibowli (IN); Arul Pugalenthi, Chenna (IN); Mazen Hammad, Irving, TX (US); Abhishek Malhotra, Manikonda (IN); Rajat Sharma, Southlake, TX (US); Ramasubramanian Radhakkrishnan, Chennai (IN)

(21) Appl. No.: 17/537,806

(22) Filed: Nov. 30, 2021

(51) Int. Cl. G06F 3/04815; G06F 3/04842; G06F 3/14; G06F 16/9537

(52) U.S. Cl. CPC G06F 3/04815; G06F 3/04842; G06F 3/1454; G06F 16/9537

(57) ABSTRACT

An illustrative extended reality (XR) presentation device detects, during an XR experience presented to a user of the XR presentation device, a selection by the user of a virtual anchor object disposed at a particular location with respect to a 3D scene within which the XR experience is presented. The XR presentation device identifies, based on anchor data associated with the virtual anchor object, a predesignated data payload that is stored by a payload server system. The payload server system is separate from the XR presentation device and stores, together with the predesignated data payload, target metadata indicating a target device to which the predesignated data payload is to be provided. The XR presentation device directs the payload server system to provide the predesignated data payload to the target device. Corresponding methods and systems are also disclosed.

### BACKGROUND INFORMATION

Computing systems and devices encode various types of information as computer data to facilitate users in accessing and using the information in various ways. As one example, computing devices may store data representative of instructions that are to be executed by the computing devices, metadata describing data being processed by the computing devices, or other information not intended for direct presentation to end users but that may nevertheless be important for proper functionality of the computing devices. As another example, computing devices may store data representative of content that can be presented to users (e.g., text content users may read, audio content users may listen to, video content users may watch, etc.).

While much of the information handled by a given computing device may be in constant flux and/or only of transient interest to a user of the computing device, it may be the case that certain data is of interest to the user frequently or in a more long-term way. For example, a user may desire ready access to certain textual content (e.g., login credentials such as a username and/or password for a particular data service or device, a textual document that the user is currently developing, etc.), certain media content (e.g., a favorite song or playlist of the user, a favorite movie or a television series the user enjoys watching every evening, etc.), or other data that the user periodically or frequently accesses.

Conventional computing systems have allowed users to organize data files in ways targeted to make accessing important data convenient (e.g., “Favorites” folders, “Recently Watched” categories in video applications, etc.). The emergence of new technologies such as extended reality, however, provides novel opportunities for improvements in how users may conveniently and efficiently access important data moving forward.

### BRIEF DESCRIPTION OF THE DRAWINGS

The accompanying drawings illustrate various implementations and are a part of the specification. The illustrated implementations are merely examples and do not limit the scope of the disclosure. Throughout the drawings, identical or similar reference numbers designate identical or similar elements.

FIG. 1 shows an illustrative extended reality (XR) presentation device for location-based accessing of predesignated data payloads using extended reality in accordance with principles described herein.

FIG. 2 shows an illustrative method for location-based accessing of predesignated data payloads using extended reality in accordance with principles described herein.

FIG. 3 shows an illustrative configuration in which the XR presentation device of FIG. 1 may operate in accordance with principles described herein.

FIG. 4 shows an illustrative 3D scene within which an XR experience is presented to a user by an implementation of the XR presentation device of FIG. 1 in accordance with principles described herein.

FIG. 5 shows an illustrative method for initializing a virtual anchor object associated with a predesignated data payload in accordance with principles described herein.

FIG. 6 shows illustrative anchor data managed by an implementation of the XR presentation device of FIG. 1 in accordance with principles described herein.

FIG. 7 shows illustrative payload data managed by a payload server system in accordance with principles described herein.

FIG. 8 shows another illustrative configuration in which the XR presentation device of FIG. 1 may operate in accordance with principles described herein.

FIG. 9 shows an illustrative computing device that may implement XR presentation devices and/or other computing systems and devices described herein in accordance with principles described herein.

### DETAILED DESCRIPTION OF EXAMPLE EMBODIMENTS

Methods and systems for location-based accessing of predesignated data payloads using extended reality (XR) are described herein. XR technologies leveraged by methods and systems described herein may include, for example, virtual reality (VR) technologies that provide VR experiences whereby users become fully immersed in a VR world in which they can move about within virtual spaces and see, hear, and/or interact with virtual objects and/or virtual avatars of other users in ways analogous to real-world experiences. As another example, XR technologies used by methods and systems described herein may include augmented reality (AR) technologies (also referred to as mixed reality technologies) that provide AR experiences whereby users continue to experience the real world around them to at least some extent (e.g., seeing real objects in their environment by way of a partially transparent heads-up display, video passed through from a camera on their device, etc.) while also being presented with virtual elements and augmentations that do not exist in the real world. Leveraging these or other XR technologies for methods and systems described herein for location-based accessing of predesignated data payloads may provide users with a more convenient and/or efficient ability to organize, access, and/or use data of interest to the user compared to conventional techniques.

For example, frequently used data or other data that a user may designate (e.g., data representing login credentials, favorite media content, links to important websites, and/or other predesignated data mentioned herein) may be associated, using methods and systems described herein, with virtual anchor objects disposed at particular locations with respect to 3D scenes within which XR experiences are presented (e.g., the real-world environment for an AR experience, a virtual environment for a VR experience, etc.). For example, login credentials (e.g., a username and/or password) for a video streaming service to which a user subscribes and periodically has to login could be associated with a virtual anchor object such as a virtual “stickie” note that is attached to a television screen that the user uses to watch the video streaming service. In other examples, other types of predesignated data may similarly be associated with other types of virtual anchor objects that may be disposed at other locations within the 3D scene. For example, a real bookshelf filled with books in a user's home may double as a virtual bookshelf that holds virtual anchor objects associated with the user's digital books or other media. Digital books may be represented on the virtual bookshelf by virtual anchor objects having the appearance of books, video files may be represented on the bookshelf by virtual anchor objects having the appearance of DVDs, audio files (or albums comprising collections of such files) may be represented on the bookshelf by virtual anchor objects having the appearance of CDs, or the like.

Various benefits and advantages arise from the combination of the physical, location-based nature of virtual anchor objects being placed in a 3D scene and the virtual nature of predesignated data payloads (e.g., the login information or media content in the examples described above) being stored and managed in accordance with methods and systems described herein. As one example, users may find it easier to remember where important information is kept when the information is associated with a physical location rather than a virtual one. This may be particularly true for information such as login credentials that may not be accessed frequently but that are important to use from time to time. While some users may easily forget where they stored a file holding a password in the file structure of their phone or laptop for example, these users may more easily remember the login information location when it is on a virtual stickie note attached to the television or another such location. At the same time, the virtual nature of the virtual anchor object storing the login information allows information to be more secure (e.g., not able to be seen by others who do not have access to the user's XR presentation device) and more persistent (e.g., not at risk of being thrown away or lost) than a physical paper note would be.

Another benefit arising from methods and systems described herein for location-based accessing of predesignated data payloads using extended reality relates to the ease with which the accessed information may be used or consumed by the user. For example, upon selection by a user of a virtual anchor object (e.g., by the user tapping on the virtual object, training his or her gaze on the object for a period of time, double-blinking while gazing at the object, etc.), the device may direct for an appropriate action to be automatically performed with respect to the predesignated data payload associated with the selected virtual anchor object. For instance, selecting the virtual anchor object associated with the login information may cause the login information to be automatically sent to the television and entered into the proper fields to sign the user into the video streaming service, while selecting a virtual anchor object associated with a particular video file may cause the video file to be automatically sent to the television (or another predesignated target device) and presented.

Yet another benefit provided by methods and systems described herein relates to efficiency and security of storage for important data (e.g., data that is important or otherwise of interest to a user). Rather than important data being stored haphazardly across various devices in a relatively unorganized and insecure manner, a central payload server system (e.g., a smart router that provides a local area network by way of which various target devices such as the television are connected, a multi-access edge compute (MEC) system that is part of a provider network to which the target devices are connected, etc.) may include or have access to sufficient storage to maintain all of the payload data in a single, secure place. In this way, data files need not be replicated (thereby wasting storage space), need not be updated in multiple locations (thereby causing inconvenience and risk that data will get out of sync if updated in one place and not another), need not be maintained by devices with highly limited storage space (phones, televisions, etc.), and need not be put at unnecessary risk by being maintained by devices with varying degrees of data security and oversight. Instead, important data may be stored and managed at the payload server system and dispatched for use by various target devices (e.g., televisions, mobile devices, artificial intelligence (AI) assistant devices, Internet of Things (IoT) devices, etc.) on demand and in a secure way.

Various specific implementations will now be described in detail with reference to the figures. It will be understood that the specific implementations described below are provided as non-limiting examples and may be applied in various situations. Additionally, it will be understood that other examples not explicitly described herein may also be captured by the scope of the claims set forth below. Methods and systems described herein for location-based accessing of predesignated data payloads using extended reality may provide any of the benefits mentioned above, as well as various additional and/or alternative benefits that will be described and/or made apparent below.

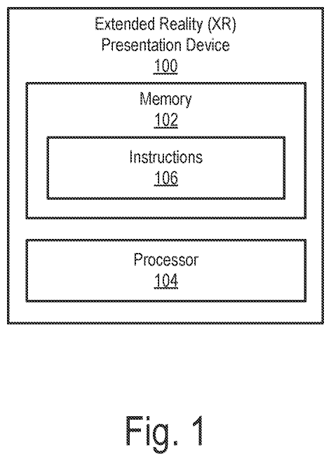

FIG. 1 shows an illustrative XR presentation device 100 (“device 100”) for location-based accessing of predesignated data payloads using extended reality in accordance with principles described herein. Device 100 may be implemented by computer resources such as processors, memory facilities, storage facilities, communication interfaces, and so forth. In various implementations, device 100 may be implemented by an AR or VR presentation device (e.g., a hand-held device, a head-mounted device, etc.), by a mobile device (e.g., a smartphone, a tablet device, etc.), by a personal computer (e.g., a laptop device, etc.), or by another suitable computing device capable of presenting an extended reality experience to the user and directing functionality of a payload server system described herein.

As shown, device 100 may include, without limitation, a memory 102 and a processor 104 selectively and communicatively coupled to one another. Memory 102 and processor 104 may each include or be implemented by computer hardware that is configured to store and/or execute computer software. Various other components of computer hardware and/or software not explicitly shown in FIG. 1 may also be included within device 100. In some examples, memory 102 and processor 104 may be distributed between multiple devices and/or multiple locations as may serve a particular implementation.

Memory 102 may store and/or otherwise maintain executable data used by processor 104 to perform any of the functionality described herein. For example, memory 102 may store instructions 106 that may be executed by processor 104. Memory 102 may be implemented by one or more memory or storage devices, including any memory or storage devices described herein, that are configured to store data in a transitory or non-transitory manner. Instructions 106 may be executed by processor 104 to cause device 100 to perform any of the functionality described herein. Instructions 106 may be implemented by any suitable application, software, script, code, and/or other executable data instance. Additionally, memory 102 may also maintain any other data accessed, managed, used, and/or transmitted by processor 104 in a particular implementation.

Processor 104 may be implemented by one or more computer processing devices, including general purpose processors (e.g., central processing units (CPUs), graphics processing units (GPUs), microprocessors, etc.), special purpose processors (e.g., application-specific integrated circuits (ASICs), field-programmable gate arrays (FPGAs), etc.), or the like. Using processor 104 (e.g., when processor 104 is directed to perform operations represented by instructions 106 stored in memory 102), device 100 may perform functions associated with location-based accessing of predesignated data payloads using extended reality as described herein and/or as may serve a particular implementation.

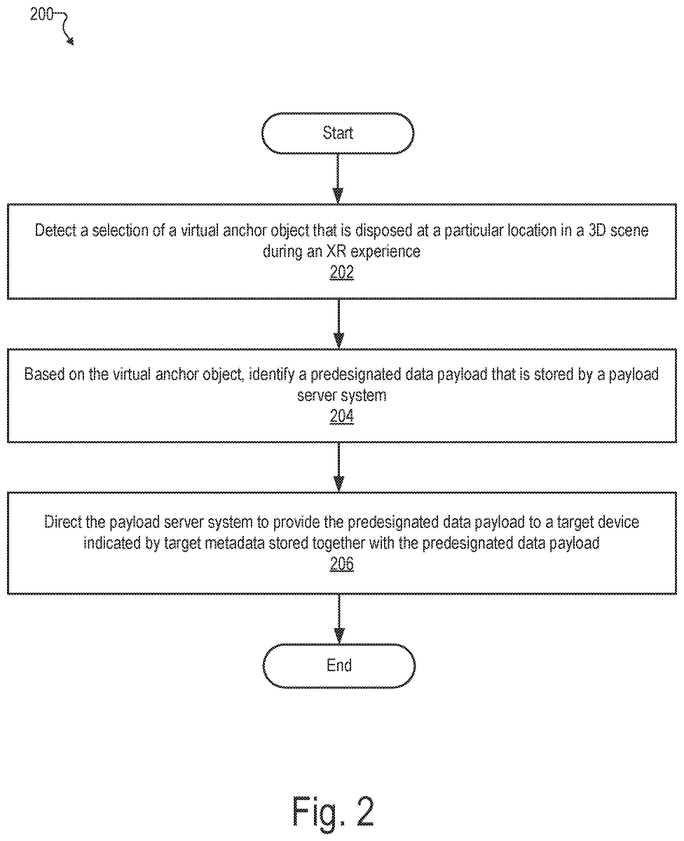

To illustrate certain functionality that processor 104 may perform, FIG. 2 shows a method 200 for location-based accessing of predesignated data payloads using extended reality in accordance with principles described herein. While FIG. 2 shows illustrative operations according to one implementation, other implementations may omit, add to, reorder, and/or modify any of the operations shown in FIG. 2. In some examples, multiple operations shown in FIG. 2 or described in relation to FIG. 2 may be performed concurrently (e.g., in parallel) with one another, rather than being performed sequentially as illustrated and/or described. One or more of the operations shown in FIG. 2 may be performed by an XR presentation device such as device 100 and/or any implementation thereof.

In some implementations, the operations of FIG. 2 may be performed in real time so as to provide, receive, process, and/or use data described herein immediately as the data is generated, updated, changed, exchanged, or otherwise becomes available. Moreover, certain operations described herein may involve real-time data, real-time representations, real-time conditions, and/or other real-time circumstances. As used herein, “real time” will be understood to relate to data processing and/or other actions that are performed immediately, as well as conditions and/or circumstances that are accounted for as they exist in the moment when the processing or other actions are performed. For example, a real-time operation may refer to an operation that is performed immediately and without undue delay, even if it is not possible for there to be absolutely zero delay. Similarly, real-time data, real-time representations, real-time conditions, and so forth, will be understood to refer to data, representations, and conditions that relate to a present moment in time or a moment in time when decisions are being made and operations are being performed (e.g., even if after a short delay), such that the data, representations, conditions, and so forth are temporally relevant to the decisions being made and/or the operations being performed.

Each of operations 202-206 of method 200 will now be described in more detail as the operations may be performed by device 100 (e.g., by processor 104 executing instructions 106 stored in memory 102).

At operation 202, device 100 may detect a selection, by a user of device 100, of a virtual anchor object. This detection may be performed during an XR experience presented to the user and the virtual anchor object may be disposed at a particular location with respect to a 3D scene within which the XR experience is presented. The 3D scene may be any real or virtual environment within which the user is engaging in the XR experience. For instance, if the XR experience is an AR experience, the 3D scene would be the real-world scene in which the user is located and the virtual anchor object would be overlaid onto real objects and scenery that are actually surrounding the user in the real world. In other implementations in which the XR experience is a VR experience, the 3D scene would be a virtual scene distinct from the real scene in which the user is located but which may be presented immersively to the user in an analogous way. In this example, certain virtual objects in the VR world may serve as virtual anchor objects associated with predesignated data payloads, while other virtual objects would not serve as virtual anchor objects for such predesignated data payloads.

The selected virtual anchor object may be one of potentially several virtual anchor objects located at various locations with respect to the 3D scene. For example, if a particular virtual anchor object is associated with a television (e.g., because the virtual anchor object is associated with a predesignated data payload representative of login credentials for a video streaming service as per the example mentioned above), the location for that particular virtual anchor object may closely associated with the television (e.g., proximate to the television, attached to the television, etc.). In other examples, locations of virtual anchor objects may be selected by the user to serve other organizational, functional, or aesthetic preferences of the user.

Each virtual anchor object presented in the 3D scene, including the virtual anchor object selected at operation 202, may be selected or implemented as any suitable virtual object as may serve a particular implementation. For example, the virtual anchor object may be implemented by text floating in the air, by a 2D or 3D geometric shape (e.g., a rectangle or box, a circle or sphere, etc.), by an object whose primary function is as a repository of information (e.g., a paper note, a book, a DVD or CD, etc.), by an object whose primary function is something other than being a repository of information (e.g., a virtual character such as an animal, virtual décor in the room, etc.), or by any other virtual object as may serve a particular implementation.

At operation 204, device 100 may identify a predesignated data payload that is stored by a payload server system. For example, this identification of the predesignated data payload may be based on anchor data that is managed by device 100 and that is associated with the virtual anchor object detected to have been selected at operation 202. Such anchor data may map various virtual anchor objects disposed at various locations with respect to the 3D scene to respective anchor identifiers corresponding to predesignated data payloads stored by a payload server system. As such, device 100 may identify the predesignated data payload at operation 204 by looking up, within the anchor data, an anchor identifier that is associated with the particular virtual anchor object selected at operation 202 and that can be used in communications with the payload server system to refer to the selected virtual anchor object and its corresponding predesignated data payload.

The payload server system storing the predesignated data payload may be separate from device 100 and may store, together with the predesignated data payload, target metadata indicating a target device to which the predesignated data payload is to be provided. For instance, if the predesignated data payload is login information for a video streaming service as described in the example above, the target device indicated in the target metadata stored at the payload server system may include the television on which the video streaming service is to be viewed. In some examples, a plurality of target devices may be associated with a single predesignated data payload and virtual anchor object. For instance, if the video streaming service could be used on the television device or on a mobile device, both the television and the mobile device may be indicated as target devices in the target metadata stored by the payload server system. As mentioned above and as will be described in more detail below, the payload server system may be implemented by an onsite router device, a MEC server or other component of a provider network, or another computing device (e.g., a set top box, an onsite server computer, a cloud-based offsite server system, etc.) that includes suitable data storage for the various predesignated data payloads and target metadata that are to be stored.

At operation 206, device 100 may direct the payload server system to provide, to the target device (or target devices) indicated in the target metadata, the predesignated data payload. The anchor identifier may be used at operation 206 to perform this directing of the payload server system. For example, in certain implementations, the directing of operation 206 may involve device 100 providing nothing more than the anchor identifier to the payload server system, whereupon the payload server system may be configured to access the appropriate predesignated data payload (based on the anchor identifier) and perform the appropriate action to provide the predesignated data payload to the appropriate target device. Conversely, in other implementations, the directing of operation 206 may involve device 100 indicating the anchor identifier along with other information. For instance, device 100 may access mapped data managed on device 100 to provide, to the payload server system, data including not only the anchor identifier but also the identity of the target device (or target devices), particular actions that are to be performed when the predesignated data payload is delivered, and so forth.

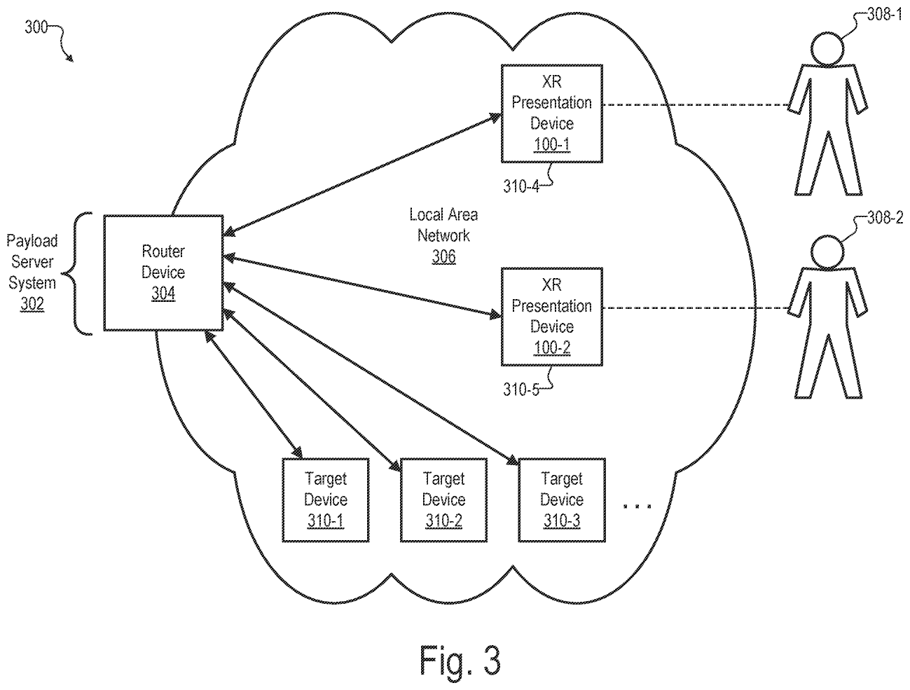

FIG. 3 shows an illustrative configuration 300 in which implementations of device 100 (labeled as XR presentation devices 100-1 and 100-2 to differentiate the implementations for clarity of reference in the following description) may operate in accordance with principles described herein. As shown in the example of configuration 300, a payload server system 302 may be implemented by a router device 304 that communicates with devices 100-1 and 100-2 by way of a local area network 306 provided by router device 304. Respective users 308-1 (for device 100-1) and 308-2 (for device 100-2) are shown to be associated with the XR presentation devices and local area network 306 is further shown to facilitate communication between router device 304 and a plurality of target devices 310. Specifically, three dedicated target devices 310 are illustrated in configuration 300 as target devices 310-1, 310-2, and 310-3, and an ellipsis indicates that more or fewer target devices than shown in FIG. 3 may be present. Additionally, because it is possible that an XR presentation device may serve as a target device for a particular predesignated data payload, FIG. 3 also labels device 100-1 as a target device 310-4, while labeling device 100-2 as a target device 310-5. Each of the elements of configuration 300 and certain ways in which these elements may interoperate in configuration 300 will now be described in more detail.

Router device 304 may represent any suitable computing device that is separate from devices 100 and operates at an onsite location at a site of the XR experience (i.e., onsite with one or more implementations of device 100 and the respective users 308). For example, the onsite location may be a home or office of one or more users 308 that are engaging in an XR experience using their respective XR presentation devices 100. As a router, router device 304 may provide a wired and/or wireless network by way of which various onsite devices, including devices 100 and/or target device 310, may intercommunicate. For instance, router device 304 may provide local area network 306 as a communicative medium by way of which devices 100 and 310 may exchange data with one another and/or with router device 304.

As will be described in more detail below, along with providing local area network 306, router device 304 may include or be communicatively coupled with a data store (e.g., one or more hard drives, a storage server, etc.) that includes sufficient storage to manage predesignated data payloads associated with any virtual anchor objects that users 308 may create and/or select in the ways described herein. For example, router device 304 may include internal data storage or may be communicatively coupled to an external data store (e.g., an external hard drive, USB flash, etc.) that router device 304 may use to manage (e.g., store, organize, provide, distribute, etc.) payload data such as will be described in more detail below. As mentioned above in relation to FIG. 2, router device 304, as an implementation of payload server system 302, may transmit or otherwise distribute this stored data to one or more target devices 310 when directed to do so by the selection of a particular virtual anchor object by one of devices 100.

In some examples, router device 304 may further perform functionality in addition to providing the network and managing the payload data. For example, router device 304 may be implemented within a cable box, set top box, digital video recorder (DVR), or other such device that also decodes incoming video data to present the video data on a television. As another example, router device 304 may be implemented by a computer server configured to further store and/or otherwise manage other data unrelated to virtual anchor objects described herein, or may be associated with an AI assistant device, a home security system, a smart appliance, or another suitable IoT device capable of performing the functions described herein.

Router device 304 may operate using a common router software platform, or any other suitable embedded software, to allow hardware components of router device 304 to interoperate with one another and/or with other devices and systems including devices 100 and 310. For example, the embedded software may support communication over Bluetooth Low Energy (BLE), WiFi, or other suitable protocols in order to manage parental passwords, detect signal strengths, perform speed test updates, and perform other suitable functions as may serve a particular implementation.

Local area network 306 may be provided by router device 304 and may facilitate or enable the performance of method 200 by devices 100 by providing a communication medium between device 100, target devices 310, and router device 304 (i.e., the payload server system in this configuration). To this end, local area network 306 may leverage any communication technologies (e.g., WiFi, Bluetooth, BLE, USB, Ethernet, etc.) configured to transport data between endpoints such as router device 304, XR presentation devices 100, target device 310, and/or other devices or systems as may be present in a particular implementation. As shown, local area network 306 may be associated with the local area of a site at which an XR experience is provided. For example, local area network 306 may enable communications between devices within a particular office space, home, or other site at which users 308 use devices 100 to engage in an XR experience.

Configuration 300 is shown to include two XR presentation devices 100 (i.e., devices 100-1 and 100-2), though it will be understood that a given configuration may include fewer or more such devices. Devices 100 may be implemented as any suitable computing devices configured to present XR experiences in any way as may serve a particular implementation. For instance, a handheld mobile device (e.g., a general-purpose mobile device such as a smartphone or tablet device) may serve as one example of an XR presentation device 100, and a head-mounted, special-purpose XR presentation device (e.g., a head-mounted AR or VR device, etc.) may serve as another example of an XR presentation device 100. In still other examples, other types of devices (e.g., laptop or desktop computers, etc.) may be employed as may serve a particular implementation. In certain examples, a display device (e.g., a head-mounted display, a handheld screen, etc.) may be integrated with processing resources of an XR presentation device within a single enclosure, while, in other examples, processing and display operations may be performed by different devices or different components of a single device (e.g., a handheld component tethered to a head-mounted component, etc.).

In FIG. 3, each device 100 is shown to be presenting an XR experience to a respective user 308. For example, users 308-1 and 308-2 may both be located together in a common 3D scene (e.g., an office or home) and may be presented with the same AR experience (i.e., seeing the same real-world space with the same virtual anchor objects and other augmentations overlaid onto the real-world environment) or with different AR experiences (i.e., seeing different virtual anchor objects and/or other augmentations overlaid onto the same real-world environment). As another example, user 308-1 and 308-2 may be in separate real-world locations (e.g., each in their own home in different cities) while both experiencing a common virtual world together in which each sees the same virtual 3D scene with either the same virtual anchor objects (e.g., objects that the users have shared with one another) or different virtual anchor objects (e.g., only the virtual anchor objects that each user 308 has himself or herself set up).

Devices 100 may be configured to perform location-based accessing of predesignated data payloads during XR experiences using operations such as those described above in relation to method 200. To this end, as will be described in more detail below, each device 100 may include not only hardware and software for presenting the XR experience (e.g., cameras, display screens, motion sensors, etc.), but also hardware and software for: 1) communicating with a payload server system such as router device 304 (e.g., BLE or WiFi communication capabilities, etc.); 2) mapping and managing anchor data to track respective locations of virtual anchor objects within the 3D scene, perform XR scene creation and XR anchor creation, save and retrieve the XR world map and handle anchor persistence, keep track of target devices to which various virtual anchor objects correspond, and so forth; and 3) providing the user experience for users 308 by presenting a user interface, receiving user input, and presenting output. Devices 100 may leverage established APIs, architectures, XR platforms, frameworks, or the like (e.g., ARKit, etc.) to form a low-level foundation on which novel anchor-specific functionality described herein may be implemented.

Target devices 310 represent any of various devices (e.g., devices on site where the XR experience is being presented) that are communicatively coupled to router device 304 (e.g., by way of local area network 306) and that may be the recipient of predesignated data payloads transmitted by router device 304 in response to a selection of a virtual anchor object by a user 308. For example, target devices 310 may include televisions, personal computers (e.g., laptops, etc.), mobile devices (e.g., smartphones, tablet devices, etc.), smart headphones, AI assistant devices, automated home devices, home security devices, smart appliances, IoT devices, and/or any other devices as may make use of predesignated data payloads that are associated with selected virtual anchor objects and stored by a payload server system such as router device 304. Target devices may transmit data (e.g., a MAC address of the target device, device details, etc.) and/or receive data (e.g., predesignated data payloads, metadata indicating an action that is to be performed with a predesignated data payload, etc.) to/from router device 304 by way of local area network 306 using WiFi, BLE, or any other communication protocols as may serve a particular implementation. As mentioned above, in certain examples, devices 100 may also act as target devices 310. For example, user 308-1 could use device 100-1 to select a virtual anchor object that will cause router device 304 to send a predesignated data payload (e.g., login information, a desired media file, etc.) to device 100-1 for presentation to user 308-1.

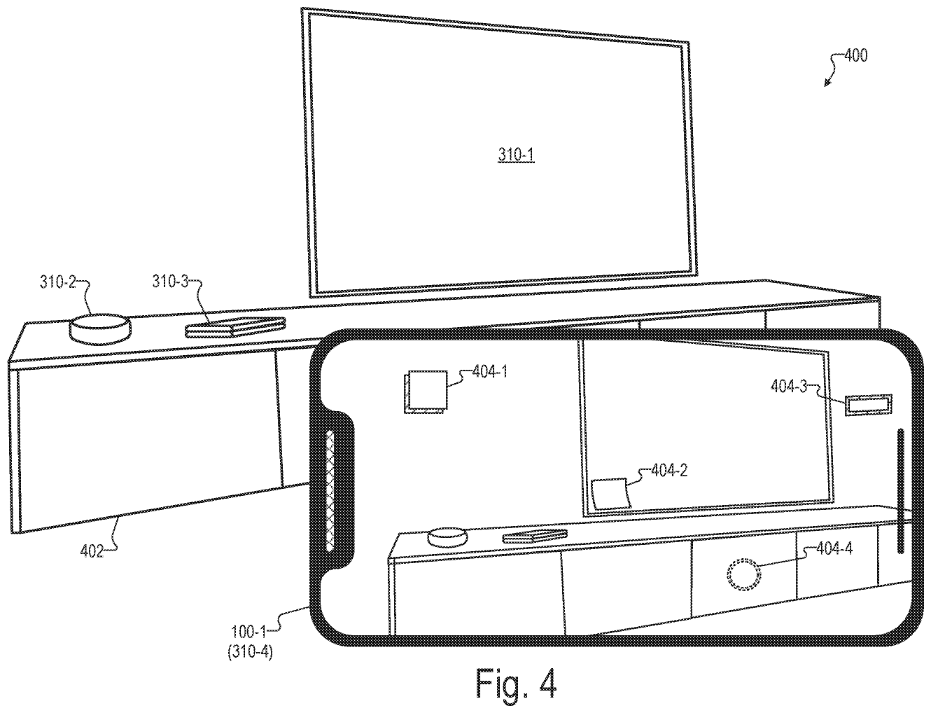

FIG. 4 shows an illustrative 3D scene 400 within which an XR experience is presented to a user (e.g., user 308-1) by an implementation or XR presentation device 100 (e.g., device 100-1) in accordance with principles described herein. In this example, the XR presentation device will be understood to be an AR presentation device, the XR experience will be understood to be an AR experience, and 3D scene 400 will be understood to be a real-world environment within which user 308-1 is located. While user 308-1 is not explicitly shown in FIG. 4, user 308-1 will be understood to be using device 100-1 from approximately the perspective from which FIG. 4 is illustrated. In other words, when user 308-1 is engaged in the AR experience, user 308-1 may have a perspective similar to that shown in FIG. 4, in which the real-world environment of 3D scene 400 (including various real-world objects) can be seen outside of the screen of device 100-1 in addition to being seen virtually on the device screen together with virtual augmentations. While this XR experience is example is based on augmented reality, it will be understood that similar principles described with respect to FIG. 4 and other figures described herein may be applied to other types of XR experiences such as VR experiences.

As shown, device 100-1 is implemented as a smartphone in the example of FIG. 4 in order to demonstrate both the non-augmented real-world environment and the augmented world of the AR experience in a single illustration. It will be understood, however, that device 100-1 could, in other examples, be implemented as a head-mounted AR presentation device (e.g., smart glasses, etc.) or any other suitable device as has been described or as may serve a particular implementation. In examples using a head-mounted device, the presentation of the augmented reality world may be more immersive than is shown in FIG. 4, such that only the augmented world on the screen (and not the non-augmented real-world environment outside of the device) can be viewed by user 308-1 while wearing the head-mounted device.

As shown outside of the screen of device 100-1, 3D scene 400 includes a piece of furniture 402 as well as several target devices 310 that predesignated data payloads could potentially be provided to. For example, target device 310-1 is shown to be a large television capable of presenting audio/video content, target device 310-2 is shown to be an AI assistant device (e.g., an AMAZON ECHO device, a GOOGLE NEST device, etc.) capable of presenting audio content and reading textual content, target device 310-3 is shown to be a laptop device (with the lid closed in FIG. 4) capable of processing data and presenting various types of multimedia, and target device 310-4 is shown to be implemented by the smartphone of device 100-1 (which, along with presenting the AR experience, may also be capable of data processing, multimedia content presentation, and so forth). While other elements of configuration 300 (e.g., router device 304, local area network 306, device 100-2, etc.) are not explicitly shown in FIG. 4, it will be understood that 3D scene 400 represents an example of the onsite location at which the XR experience of configuration 300 is being presented, and that these other elements may be present at the scene even though they are not explicitly depicted.

As shown on the screen of device 100-1, an AR world presented by device 100-1 as part of the AR experience includes not only the real-world objects of 3D scene 400 (i.e., furniture 402, the various target device 310, etc.) but also includes several virtual anchor objects 404 (e.g., virtual anchor objects 404-1 through 404-4) located at various locations with respect to 3D scene 400. It is noted that virtual anchor objects 404 are all virtual; that is, these objects are not actually present in the real world (as can be seen outside of the screen). Even still, each virtual anchor object 404 is presented at a particular real-world location with respect to 3D scene 400 so as to provide the benefits described herein of allowing users to store important data in ways that are fully digital but that are also integrated with the physical world.

As has been described, the function of virtual anchor objects such as virtual anchor objects 404 may be to visually represent hotspots for storage of specific data that has been predesignated (e.g., data that the user frequently wishes to access, important data that the user accesses infrequently thereby making it easy to misplace, data that the user wishes to spatially organize in a particular way with respect to the real world, etc.). For example, as mentioned above, predesignated data payloads associated with various virtual anchor objects 404 may include data such as login credentials (e.g., usernames, passwords, etc.), saved settings (e.g., parental controls, DVR bookmarks, etc.), multimedia content (e.g., text data, audio data, video data, interactive video games or XR data, etc.), and/or any other suitable data payloads as may serve a particular implementation.

As shown, the virtual objects presented as virtual anchor objects 404 may take any suitable shape or form. As a few non-limiting examples, virtual anchor object 404-1 is shown to have a square shape and to cast a shadow suggesting that it is floating in the air in front of the wall, virtual anchor object 404-2 is shown to be a paper stickie note appearing to be attached to the corner of the television (e.g., to hold textual login information for accessing the television or a service accessed by way of the television), virtual anchor object 404-3 is a more ornamented object with a rectangular shape, and virtual anchor object 404-4 is depicted as a circle with dotted lines indicating that this object may actually be disposed (e.g., hidden) inside of a compartment of furniture 402 (i.e., so as to only be selectable when the compartment is opened). Other virtual anchor objects may take other shapes, sizes, and forms than those explicitly illustrated in FIG. 4. Additionally, in certain examples, virtual anchor objects may be made to appear as real-world objects to blend in with the room (e.g., other furnishings, objects such as remote controls or framed artwork, etc.), may be animated or may appear to come to life (e.g., as animal characters, etc.), or the like.

User 308-1 may select any of virtual anchor objects 404 to cause the predesignated data payload associated with that virtual anchor object 404 to be provided to a target device with which the virtual anchor object 404 is associated. For instance, if virtual anchor object 404-2 is associated with a login credential payload that is to be entered into a video streaming service presented on the television of target device 310-1, user 308-1 may cause the login credentials to be automatically sent to the television and properly entered into the appropriate login fields of the video streaming service by selecting virtual anchor object 404-2. The selecting of a virtual anchor object 404 may be performed in any suitable way. For instance, if the XR experience is presented on a device such as the smartphone of device 100-1 shown in FIG. 4, the selection may include tapping or swiping on the virtual anchor object 404 that the user wishes to select and possibly confirming that the user wishes to proceed with the data transfer. In other examples (e.g., for other types of XR presentation devices, etc.), other selection methods may be used. For instance, for a head-mounted AR device (e.g., smart glasses, etc.) that is designed to present a hands-free AR experience, a virtual anchor object 404 may be selected by a blink-based indication performed by the user (e.g., quickly blinking twice in succession, etc.), by a gaze-based indication performed by the user (e.g., gazing at the virtual anchor object 404 for a threshold amount of time), or in another suitable way.

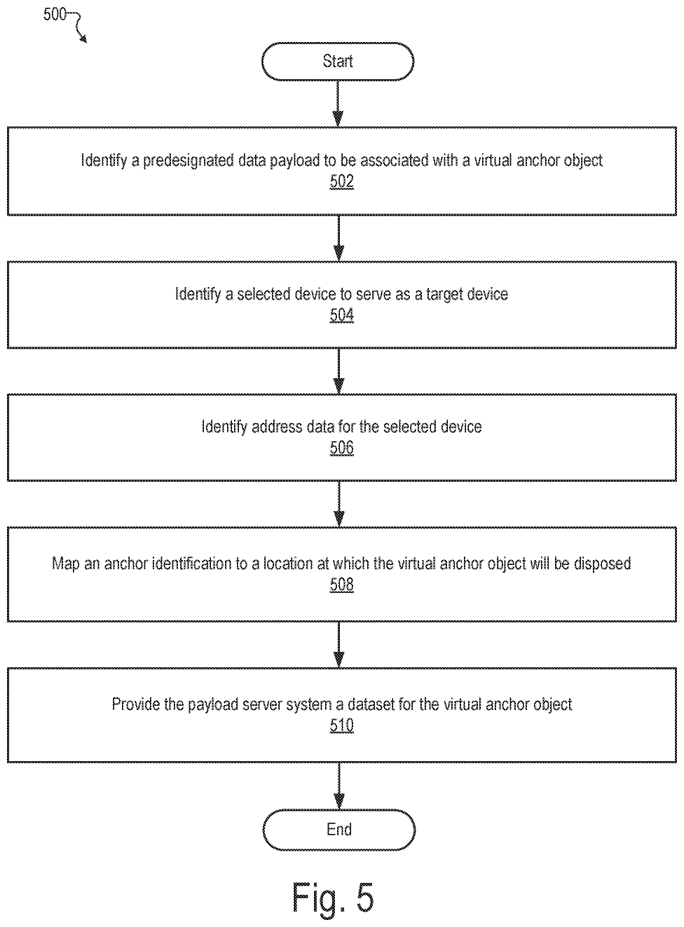

FIG. 5 shows an illustrative method 500 for initializing a virtual anchor object associated with a predesignated data payload in accordance with principles described herein. For example, prior to an XR experience such as the AR experience illustrated in FIG. 4, an XR presentation device such as device 100-1 may initialize each of virtual anchor objects 404 in accordance with a procedure such as set forth in method 500. Similarly as describe above in relation to method 200, while FIG. 5 shows illustrative operations of method 500 according to one implementation, other implementations may omit, add to, reorder, and/or modify any of the operations shown in FIG. 5. In some examples, multiple operations shown in FIG. 5 or described in relation to FIG. 5 may be performed concurrently (e.g., in parallel) with one another, rather than being performed sequentially as illustrated and/or described. One or more of the operations shown in FIG. 5 may be performed by an XR presentation device such as device 100 and/or any implementation thereof (e.g., one of devices 100-1 or 100-2, etc.).

Each of operations 502-510 of method 500 will now be described in more detail as the operations may be performed by an implementation of device 100 such as one of devices 100-1 or 100-2 described above.

At operation 502, device 100 may identify a predesignated data payload that is to be associated with a virtual anchor object that is to be initialized by way of method 500. As has been described, the predesignated data payload identified at operation 502 may include, for example: login credentials or other important information that a user may desire to safeguard and access at a future time, textual content such as a digital book or playlist, multimedia content such as an audio file, video file, interactive application, web page, or the like; or any other data as a user may desire to store and have provided to a particular target device. In some examples, operation 502 may involve a manual entry of data (e.g., by way of a keyboard, etc.) or a selection of data (e.g., from a file system or the like) by a user of device 100.

At operation 504, device 100 may identify a selected device to serve as the target device that will ultimately be provided the predesignated data payload that was identified at operation 504. This selected device may be chosen from a plurality of devices accessible to the payload server system. For instance, in the example of configuration 300, the selected device may be any of target devices 310 that are connected to local area network 306 and thereby accessible to router device 304. In certain examples, device 100 may operate in a BLE Central mode to scan the environment to identify the available target devices by scanning across the XR experience site (e.g., across local area network 306, etc.) to identify device names, device MAC identifiers, and/or other identifiers or details for accessible devices that may be selectable as target devices for the given predesignated data payload. In some examples, operation 504 may involve producing a list of accessible devices that the user may select from to allow device 100 to identify the selected device. While a single selected device is described in this example, it will be understood (and described in more detail below) that a plurality of devices may be selected to receive a given predesignated data payload in certain scenarios or implementations.

At operation 506, device 100 may identify address data for the selected device. For example, based on a selection identified at operation 504 (e.g., a selection made by the user and detected by device 100) and based on the device information (e.g., device names, device MAC identifiers, etc.) collected at operation 504, device 100 may identify a target address (e.g., a MAC identifier, an IP address looked up using a MAC identifier, etc.) that can be used by the payload server system to distribute payload data to the selected target device.

At operation 508, device 100 may map an anchor identifier associated with the virtual anchor object to a location within the 3D scene selected to serve as the particular location at which the virtual anchor object will be disposed during the XR experience. For example, this mapping may take place within anchor data managed by device 100 (the anchor data was mentioned above and will be described in more detail below). The anchor identifier may be any suitable number or other identifier that is associated with the virtual anchor object being initialized and, as will be described and illustrated below, may be used to distinguish the present virtual anchor object from other virtual anchor objects both in the anchor data managed by device 100 and in payload data managed by the payload server system.

The location within the 3D scene may be selected for the virtual anchor object by the user in any suitable way. For instance, the user may use tapping, swiping, blinking, typing, clicking, or other input techniques or gestures to designate a particular location with respect to the 3D scene where the user desires to place the virtual anchor object being initialized. In some implementations, a finite number of potential locations may be identified and offered as options by the system to the user to select between rather than giving the user free reign to designate any location at will. Along with identifying the location and anchor identifier at this mapping operation, device 100 may further define other properties of the virtual anchor object (e.g., the shape and appearance of the virtual anchor object, the size of the virtual anchor object, etc.) and store these properties in the anchor data as well. In this way, device 100 may present each virtual anchor object at its proper location and with its desired properties during the XR experience and, when the virtual anchor object is selected, may provide sufficient information to the payload server system to direct the delivery of the predesignated data payload to the target device.

At operation 510, device 100 may provide a dataset for the virtual anchor object for storage by the payload server system. That is, along with storing data for the virtual anchor object being initialized in the anchor data managed by device 100, device 100 may further provide a dataset associated with the virtual anchor object for use by the payload server system. Unlike the data stored for the virtual anchor object in the anchor data managed by device 100, the dataset provided to the payload server system at operation 510 may include the predesignated data payload itself, as well as target metadata such as the anchor identifier, the address data for the selected target device, data indicative of an action that the target device is to perform with the predesignated data payload, and any other suitable data. As will be illustrated below, because the dataset stored by the payload server system may include the same anchor identifier stored in the anchor data at device 100, the dataset stored at the payload server system may omit the location data of the virtual anchor object just as the anchor data stored at the XR presentation device may omit the predesignated data payload. The providing of the dataset at operation 510 may be performed by way of a WiFi data transfer, a BLE data transfer, or by any other suitable data transfer to be received by the software platform of the router device described above.

Method 500 may be performed prior to a given XR experience for each virtual anchor object that is to be presented during the XR experience. For instance, for the AR experience example illustrated in FIG. 4 with four virtual anchor objects 404, it will be understood that method 500 may have been performed at least four separate times to initialize each of virtual anchor objects 404 (along with any additional times to initialize any additional virtual anchor objects that are present at 3D scene 400 but are out of frame or otherwise not shown in FIG. 4). Then, during the XR experience, method 200 or a similar procedure may be performed in order that the initialized virtual anchor objects may be put to use for location-based accessing of predesignated data payloads. For instance, in accordance with method 200, device 100-1 may scan 3D scene 400 using an AR camera incorporated into device 100-1, recognize the environment and load the world map of the AR scene, authenticate the user and scan for the user's virtual anchor objects in the 3D scene, detect a user gesture (e.g., tap, swipe, etc.) with respect to a particular virtual anchor object, and send the anchor identifier to the payload server system (e.g., router device 304) to direct the payload server system to send the predesignated data payload for the anchor identifier to the target device indicated by the target address. At this point, the target device may receive the data from the payload server system and perform an action with the data (e.g., a default action or a specifically-directed action such as presenting the content, storing the content, etc.).

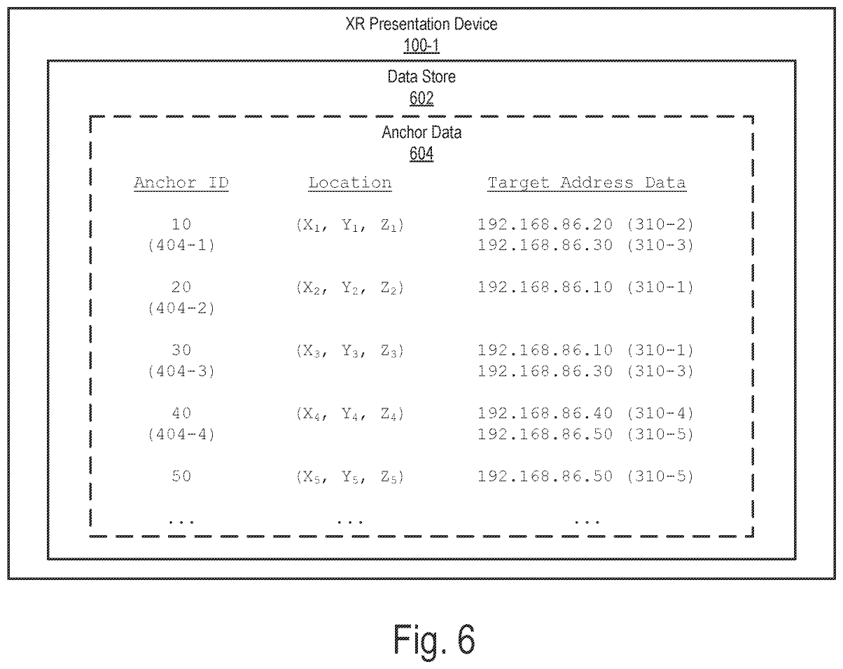

FIG. 6 shows illustrative anchor data managed by an implementation of XR presentation device 100 in accordance with principles described herein. Specifically, as shown, device 100-1 may include a data store 602 (e.g., included within or otherwise associated with memory 102) that stores anchor data 604 comprising anchor identifier information (“Anchor ID”), location information (“Location”), and target address information (“Target Address Data”) for each of various virtual anchor objects such as virtual anchor objects 404 described above. For purposes of illustration, FIG. 6 continues the AR experience example of FIG. 4 by assigning an anchor identifier of “10” to virtual anchor object 404-1, an anchor identifier of “20” to virtual anchor object 404-2, an anchor identifier of “30” to virtual anchor object 404-3, an anchor identifier of “40” to virtual anchor object 404-4, and an anchor identifier of “50” to another virtual anchor object not explicitly shown in FIG. 4. Each of these anchor identifiers is shown to be associated with respective locations indicated, in this example, using cartesian coordinates (X, Y, Z) with respect to a coordinate system of the 3D scene. Specifically, as shown, anchor identifier 10 (for virtual anchor object 404-1) is associated with coordinates (X₁, Y₁, Z₁), anchor identifier 20 (for virtual anchor object 404-2) is associated with coordinates (X₂, Y₂, Z₂), and so forth.

Each of the anchor identifiers of anchor data 604 is also shown to be associated with one or more target addresses that have been identified for the designated target devices 310 described above. For example, as shown, anchor identifier 10 (for virtual anchor object 404-1) is associated with target devices at target addresses “192.168.86.20” (understood to be an address of the AI assistant target device 310-2) and “192.168.86.30” (understood to be an address of the laptop computer target device 310-3). Anchor identifier 20 (for virtual anchor object 404-2) is associated with the target device at target address “192.168.86.10” (understood to be an address of the television target device 310-1). Anchor identifier 30 (for virtual anchor object 404-3) is associated with target devices at target addresses “192.168.86.10” and “192.168.86.30”. Anchor identifier 40 (for virtual anchor object 404-4) is associated with target devices at target addresses “192.168.86.40” (understood to be an address of the XR presentation target device 310-4, (a.k.a., device 100-1)) and “192.168.86.50” (understood to be an address of the XR presentation target device 310-5 (a.k.a., device 100-2)). Anchor identifier 50 (for a virtual anchor object that is not shown in FIG. 4) is associated with the target device at target address “192.168.86.50”. Ellipsis at the bottom of each data category indicate that additional virtual anchor objects may also be represented within anchor data 604 if these have been initialized. As has been noted and as explicitly illustrated by the example of anchor identifier 40, the target device indicated by the anchor data and to which the predesignated data payload is to be provided (as well as indicated by the target metadata provided to the payload server system based on the anchor data) may be the same XR presentation device (i.e., device 100-1 in this example) that stores the anchor data (and provides the target metadata).

In certain implementations, virtual anchor objects represented in the anchor data of a particular XR presentation device may be stored securely so as to be private to the particular user of the XR presentation device (e.g., user 308-1 of device 100-1 in this example). It will be understood however, that, if the user so desires, it may be possible for the user to share some or all of anchor data 604 with another user to allow the other user to also access the virtual anchor objects initialized and/or managed by device 100-1. For example, if directed to by user 308-1, device 100-1 may transmit anchor data 604 (e.g., a portion or an entirety of the anchor data) from device 100-1 to an additional XR presentation device used by an additional user (e.g., to device 100-2 used by user 308-2) to present, to the additional user, an additional XR experience within the 3D scene. In this scenario, the additional XR experience would then incorporate, based on the transmitted anchor data 604, each of the virtual anchor objects 404 at their respective locations so as to be selectable by the additional user.

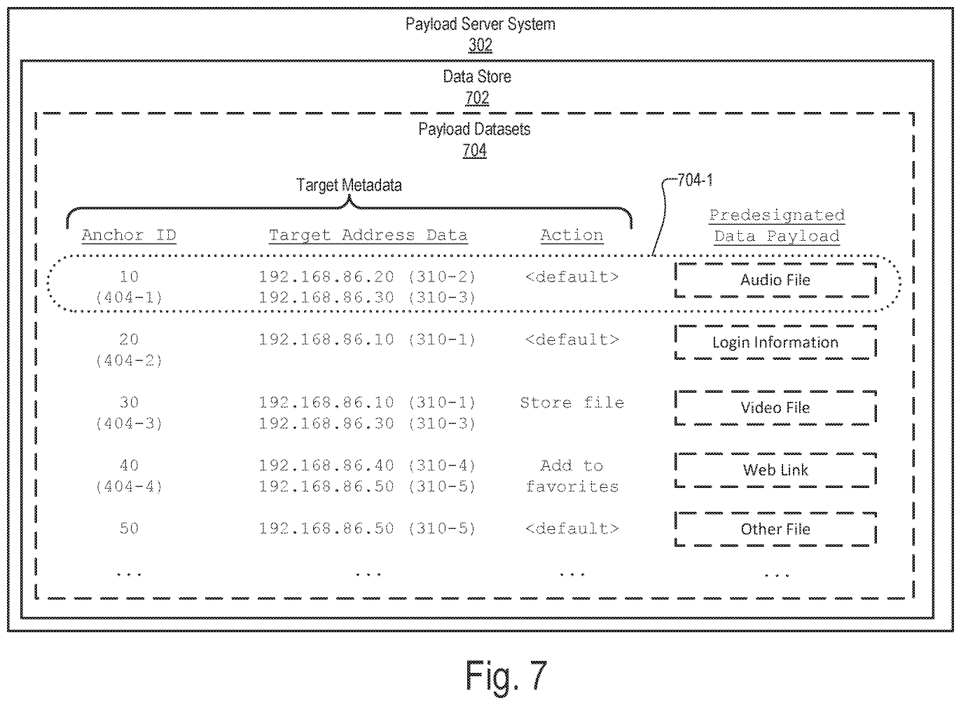

FIG. 7 shows illustrative payload data managed by a payload server system in accordance with principles described herein. Specifically, as shown, payload server system 302 (which may be implemented by router device 304 as shown in FIG. 3 or by another suitable computing system) may include or be communicatively coupled to a data store 702 (e.g., internal storage, external storage connected to the payload server system, etc.) that stores a number of payload datasets 704. To illustrate, one of the payload datasets 704 is circled with a dotted line labeled as payload dataset 704-1. As shown by payload dataset 704-1 (and the other payload datasets 704 that are not explicitly labeled in this manner), each payload dataset 704 may include target metadata comprising anchor identifier information (“Anchor ID”), target address information (“Target Address Data”) and action instruction data (“Action”) for each of various virtual anchor objects such as the virtual anchor objects 404 that have been described. Additionally, each payload dataset 704 may include the data of the associated predesignated data payload (“Predesignated Data Payload”), which is illustrated in FIG. 7 by boxes outlined with dashed lines.

FIG. 7 continues to use the AR experience example illustrated in of FIGS. 4 and 6, and, as mentioned above, payload datasets 704 include certain target metadata that overlaps with anchor data 604 managed by device 100-1 in FIG. 6. At the same time, it is noted that payload datasets 704 do not replicate all of the data used by device 100-1 (e.g., there is no need for the payload server system 302 to track the location information, for instance) and that payload datasets 704 further include data not stored as part of the anchor data of FIG. 6 (e.g., the actual predesignated data payloads are stored in payload server system 302, though they are not stored in device 100-1).

Payload datasets 704 are present in FIG. 7 for all the same anchor identifiers (i.e., 10, 20, 30, 40, and 50, associated with the same virtual anchor objects 404) as described above in relation to anchor data 604. The same target address data for each of these virtual anchor objects is also shown to be included within the target metadata stored by payload server system 302. In particular, as described above in relation to the anchor data, the target metadata of FIG. 7 is shown to indicate, for at least some of the virtual anchor objects, more than one target device, of a plurality of devices accessible to payload server system 302, to which particular predesignated data payloads are to be provided when the virtual anchor objects are selected by the user. For example, the target metadata for virtual anchor object 404-1 (with anchor identifier 10) in payload dataset 704-1 is shown to indicate both target devices 310-2 and 310-3 by their respective addresses.

In some implementations, the target metadata may include additional information beyond the anchor identifiers and target addresses provided by the XR presentation device during the initialization of the virtual anchor objects. For example, as shown in this example, the target metadata stored together with the predesignated data payload may further indicate an action that the target device(s) is/are to perform with respect to the predesignated data payload upon receiving the predesignated data payload from payload server system 302. This action may be any suitable action that can be taken with respect to the predesignated data payload given the capabilities of the selected target devices. For example, multimedia content such as a video file could be presented (e.g., rendered, played, etc.), stored, added to a playlist, added as an attachment to a message, or used in various other ways. As another example, login credential information could be entered into sign-in fields associated with a variety of different authentications and services. For instance, a username and password may be used to gain access to a computer (e.g., to get past the lock screen), to log into one of various applications running on the computer, to log into a web service accessed by a browser on the computer, or used in other ways.

Based on an action indicated in the target metadata, the target device(s) may be directed to automatically use the data such as by automatically entering the username and password to certain fields so as to automatically authenticate the user and gain access to the device or service in question, by automatically beginning playback of multimedia content, or otherwise by automatically applying the data for its intended use. In this way, the user may conveniently forego having to, for example, type in the credential information or find a folder into which the downloaded content was transferred to manually begin playback of the content. While the action instruction information is illustrated to be stored only as part of the target metadata of payload datasets 704 in this example (and not as part of anchor data 604), it will be understood that, in certain implementations, the action instruction information may instead be stored in anchor data 604 (and provided together with the anchor identifier when device 100-1 detects a selection of a particular virtual anchor object), or stored in both anchor data 604 and payload datasets 704. (It is noted that the same flexibility may also apply to the target address data, which, in this example, is shown to be included in both anchor data 604 and payload datasets 704.)

In certain cases, a predesignated data payload may be of a data type that is associated with a default action that the target device is to perform absent an overriding indication by the target metadata. For example, a default action for an audio file may be to present the audio file by way of a currently selected audio output (e.g., speakers, headphones, etc.) of the target device. Similarly, a default action for a video file may be to present the video file on a screen of the target device and by way of the audio output. A default action for login credential information may be to be entered into login fields currently displayed on the target device or to be entered into login fields for a particular device or service. Payload dataset 704-1 illustrates an example of a predesignated data payload that is to be applied using a default action (“<default>”) of this type, and other payload datasets 704 (e.g., those associated with anchor identifiers 20 and 50) similarly rely on the default action.

Other payload datasets 704, however, are shown to indicate overriding action information other than the default. In these cases (e.g., payload datasets 704 associated with anchor identifiers 30 and 40), the target metadata indicates respective overriding actions that the target devices are to perform, instead of any default action, with respect to the predesignated data payload. Specifically, for example, the payload dataset 704 associated with anchor identifier 30 indicates that the video file of the predesignated data payload (“Video File”) is to be stored (“Store file”) rather than presented (as may be the default action for a video file). As another example, the payload dataset 704 associated with anchor identifier 40 indicates that the web link of the predesignated data payload (“Web Link”) is to be added to a favorites folder (“Add to favorites”) rather than entering the link into a browser to access information at the link (as may be the default action for a web link). Various other examples of default actions and overriding actions may be employed for other purposes and datatypes as a user may direct and/or as may serve a particular implementation.

As has been mentioned, various types of predesignated data payloads may be stored by the payload server system 302. For example, as illustrated by the “Audio File” predesignated data payload associated with anchor identifier 10 and the “Video File” predesignated data payload associated with anchor identifier 30, the predesignated data payload may include a media file representative of media content (e.g., audio content, video content, etc.) that the target device is capable of presenting. As another example illustrated by the “Login Information” predesignated data payload associated with anchor identifier 20, the predesignated data payload may include a password configured to allow access to a performance capability or data store of the target device. For example, the performance capability may be accessed be logging into a device and the data store may be accessed by logging into a service (e.g., a video streaming service, etc.) or logging in to access encrypted data (e.g., a locked file or an encrypted hard drive, etc.).

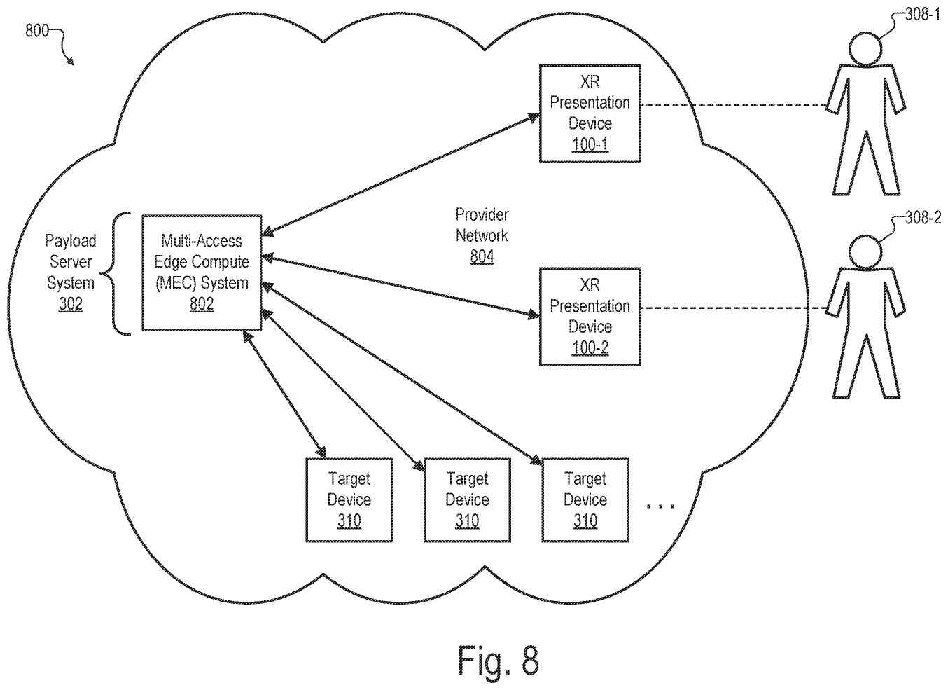

FIG. 8 shows another illustrative configuration (in addition to configuration 300 described above in relation to FIG. 3) in which implementations of device 100 may operate in accordance with principles described herein. As shown, a configuration 800 in FIG. 8 includes various similarities with configuration 300 while being changed in a few respects. More particularly, this example shows the same two implementations of XR presentation device 100 (i.e., devices 100-1 and 100-2) being used by users 308-1 and 308-2, respectively. Various target devices 310 (not explicitly differentiated in the labeling of FIG. 8) are also shown in configuration 800. While, like configuration 300, all of these devices are communicatively coupled to a payload server system 302, configuration 800 differs from configuration 300 in how payload server system 302 is implemented, as well as in the network used to communicatively couple all the systems and device.

In configuration 800, payload server system 302 is shown to be implemented by a MEC system 802 that will be understood to be operating at an offsite location separate from a site of the XR experience (where devices 100 and users 308 are located). As further shown, MEC system 802 may communicate with devices 100 and target device 310 by way of a provider network 804 that incorporates MEC system 802. Provider network 804 may include any network or networks configured to transport data between endpoints such as MEC system 802, one or more XR presentation devices 100, one or more target devices 310, and/or other devices or systems as may be present in a particular implementation. In some examples, provider network 804 may include a cellular data network (e.g., a 5G network or data network of another suitable generation) that is managed by a service provider such as a telecommunications service provider (e.g., a cellular service provider), an application service provider, a storage service provider, an internet service provider, or the like.

As shown, MEC system 802 may be implemented within provider network 804. For example, MEC system 802 may be implemented on the edge of the provider network within a network element such as a radio access network, a transport access point, a service access point, or another such element of the provider network. In other embodiments, MEC system 802 could be replaced by a cloud-based system that is connected to provider network 804 rather than implemented thereby. While a cloud-based system may take advantage of certain economies of scale (along with associated efficiencies and other advantages associated therewith) that may not be available for MEC system 802, MEC-based systems may be configured to provide more responsive computational support to XR presentation devices 100 and target devices 310.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium (e.g., a memory, etc.), and executes those instructions, thereby performing one or more operations such as the operations described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random-access memory (DRAM), which typically constitutes a main memory. Common forms of computer-readable media include, for example, a disk, hard disk, magnetic tape, any other magnetic medium, a compact disc read-only memory (CD-ROM), a digital video disc (DVD), any other optical medium, random access memory (RAM), programmable read-only memory (PROM), electrically erasable programmable read-only memory (EPROM), FLASH-EEPROM, any other memory chip or cartridge, or any other tangible medium from which a computer can read.

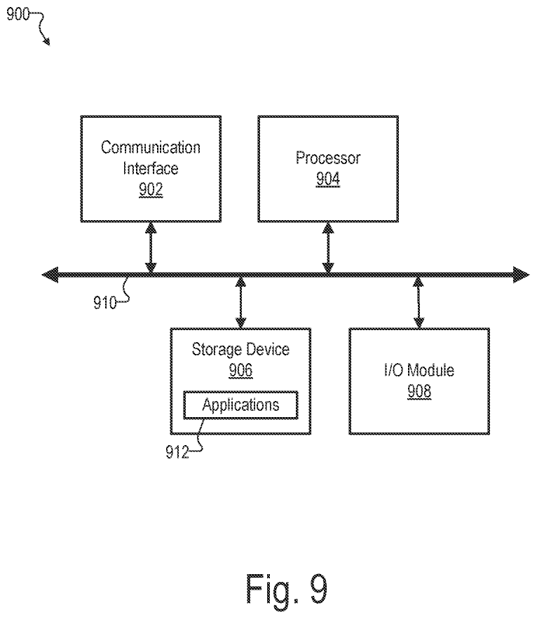

FIG. 9 shows an illustrative computing device 900 that may implement XR presentation devices and/or other computing systems and devices described herein in accordance with principles described herein. For example, computing device 900 may include or implement (or partially implement) an XR presentation device such as device 100, components included therein, or other devices or systems associated therewith and/or described herein (e.g., any of target devices 310, any implementation of payload server system 302, etc.).

As shown in FIG. 9, computing device 900 may include a communication interface 902, a processor 904, a storage device 906, and an input/output (I/O) module 908 communicatively connected via a communication infrastructure 910. While an illustrative computing device 900 is shown in FIG. 9, the components illustrated in FIG. 9 are not intended to be limiting. Additional or alternative components may be used in other embodiments. Components of computing device 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a modem, an audio/video connection, and any other suitable interface.

Processor 904 generally represents any type or form of processing unit capable of processing data or interpreting, executing, and/or directing execution of one or more of the instructions, processes, and/or operations described herein. Processor 904 may direct execution of operations in accordance with one or more applications 912 or other computer-executable instructions such as may be stored in storage device 906 or another computer-readable medium.

Storage device 906 may include one or more data storage media, devices, or configurations and may employ any type, form, and combination of data storage media and/or device. For example, storage device 906 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 906. For example, data representative of one or more executable applications 912 configured to direct processor 904 to perform any of the operations described herein may be stored within storage device 906. In some examples, data may be arranged in one or more databases residing within storage device 906.

I/O module 908 may include one or more I/O modules configured to receive user input and provide user output. One or more I/O modules may be used to receive input for a single virtual experience. I/O module 908 may include any hardware, firmware, software, or combination thereof supportive of input and output capabilities. For example, I/O module 908 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 900. For example, one or more applications 912 residing within storage device 906 may be configured to direct processor 904 to perform one or more processes or functions associated with processor 104 of device 100. Likewise, memory 102 of device 100 may be implemented by or within storage device 906.

To the extent the aforementioned embodiments collect, store, and/or employ personal information of individuals, groups, or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information may be in an appropriately secure manner reflective of the type of information, for example, through various access control, encryption, and anonymization techniques for particularly sensitive information.

In the preceding specification, various example embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The specification and drawings are accordingly to be regarded in an illustrative rather than a restrictive sense.

What is claimed is:

1. A method comprising:
detecting, by an extended reality (XR) presentation device during an XR experience presented to a user of the XR presentation device, a selection by the user of a virtual anchor object disposed at a particular location with respect to a 3D scene within which the XR experience is presented;
identifying, by the XR presentation device and based on anchor data associated with the virtual anchor object, a predesignated data payload that is stored by a payload server system, wherein the payload server system is separate from the XR presentation device and stores, together with the predesignated data payload, target metadata indicating a target device to which the predesignated data payload is to be provided; and
directing, by the XR presentation device, the payload server system to provide, to the target device, the predesignated data payload.

2. The method of claim 1, further comprising initializing, by the XR presentation system prior to the XR experience, the virtual anchor object, the initializing of the virtual anchor object including:
identifying the predesignated data payload that is to be associated with the virtual anchor object;
identifying a selected device, of a plurality of devices accessible to the payload server system, to serve as the target device;
identifying address data for the selected device;
mapping, within the anchor data, an anchor identifier associated with the virtual anchor object to a location within the 3D scene selected to serve as the particular location at which the virtual anchor object will be disposed during the XR experience; and
providing, for storage by the payload server system, a dataset for the virtual anchor object, the dataset comprising the predesignated data payload and the target metadata, the target metadata including the anchor identifier and the address data for the selected device.

3. The method of claim 1, wherein the target metadata stored together with the predesignated data payload further indicates an action that the target device is to perform with respect to the predesignated data payload upon receiving the predesignated data payload from the payload server system.

4. The method of claim 1, wherein the predesignated data payload includes a password configured to allow access to a performance capability or data store of the target device.

5. The method of claim 1, wherein the predesignated data payload includes a media file representative of media content that the target device is capable of presenting.

6. The method of claim 1, further comprising transmitting the anchor data from the XR presentation device to an additional XR presentation device used by an additional user to present, to the additional user, an additional XR experience within the 3D scene;
wherein, based on the transmitted anchor data, the additional XR experience incorporates the virtual anchor object at the particular location so as to be selectable by the additional user.

7. The method of claim 1, wherein the target metadata further indicates an additional target device, of a plurality of devices accessible to the payload server system, to which the predesignated data payload is also to be provided when the virtual anchor object is selected by the user.

8. The method of claim 1, wherein:
the predesignated data payload is of a data type associated with a default action that the target device is to perform absent an overriding indication by the target metadata; and
the target metadata further indicates an overriding action that the target device is to perform, instead of the default action, with respect to the predesignated data payload.

9. The method of claim 1, wherein the target device indicated by the target metadata and to which the predesignated data payload is to be provided is the XR presentation device.

10. The method of claim 1, wherein:
the XR presentation device is an augmented reality presentation device;
the XR experience is an augmented reality experience; and
the 3D scene is a real-world environment within which the user is located.

11. The method of claim 1, wherein the payload server system is implemented by a router device operating at an onsite location at a site of the XR experience, the router device communicating with the XR presentation device and the target device by way of a local area network provided by the router device.

12. The method of claim 1, wherein the payload server system is implemented by a multi-access edge compute (MEC) system operating at an offsite location separate from a site of the XR experience, the MEC system communicating with the XR presentation device and the target device by way of a provider network that incorporates the MEC system.

13. A device comprising:
a processor configured to:
detect, during an extended reality (XR) experience presented to a user of the device, a selection by the user of a virtual anchor object disposed at a particular location with respect to a 3D scene within which the XR experience is presented;
identify, based on anchor data associated with the virtual anchor object, a predesignated data payload that is stored by a payload server system, wherein the payload server system is separate from the device and stores, together with the predesignated data payload, target metadata indicating a target device to which the predesignated data payload is to be provided; and
direct the payload server system to provide, to the target device, the predesignated data payload.

14. The device of claim 13, wherein the processor is further configured to initialize, prior to the XR experience, the virtual anchor object, the initializing of the virtual anchor object including:
identifying the predesignated data payload that is to be associated with the virtual anchor object;
identifying a selected device, of a plurality of devices accessible to the payload server system, to serve as the target device;
identifying address data for the selected device;
mapping, within the anchor data, an anchor identifier associated with the virtual anchor object to a location within the 3D scene selected to serve as the particular location at which the virtual anchor object will be disposed during the XR experience; and
providing, for storage by the payload server system, a dataset for the virtual anchor object, the dataset comprising the predesignated data payload and the target metadata, the target metadata including the anchor identifier and the address data for the selected device.

15. The device of claim 13, wherein the target metadata stored together with the predesignated data payload further indicates an action that the target device is to perform with respect to the predesignated data payload upon receiving the predesignated data payload from the payload server system.

16. The device of claim 13, wherein the predesignated data payload includes a password configured to allow access to a performance capability or data store of the target device.

17. The device of claim 13, wherein the predesignated data payload includes a media file representative of media content that the target device is capable of presenting.

18. The device of claim 13, wherein:
the processor is further configured to transmit the anchor data from the device to an additional device used by an additional user to present, to the additional user, an additional XR experience within the 3D scene; and
based on the transmitted anchor data, the additional XR experience incorporates the virtual anchor object at the particular location so as to be selectable by the additional user.

19. The device of claim 13, wherein the target metadata further indicates an additional target device, of a plurality of devices accessible to the payload server system, to which the predesignated data payload is also to be provided when the virtual anchor object is selected by the user.

20. A non-transitory computer-readable medium storing instructions that, when executed, direct a processor of an extended reality (XR) presentation device to:
detect, during an XR experience presented to a user of the XR presentation device, a selection by the user of a virtual anchor object disposed at a particular location with respect to a 3D scene within which the XR experience is presented;
identify, based on anchor data associated with the virtual anchor object, a predesignated data payload that is stored by a payload server system, wherein the payload server system is separate from the XR presentation device and stores, together with the predesignated data payload, target metadata indicating a target device to which the predesignated data payload is to be provided; and
direct the payload server system to provide, to the target device, the predesignated data payload.
